(19) United States
(12) Patent Application Publication
(10) Pub. No.: US 2004/0037408 A1
(43) Pub. Date: Feb. 26, 2004

(54) Automatic messaging system

(76) Inventors: Thomas Van Zandt, Sunnyvale, CA (US); Patience Van Zandt, Sunnyvale, CA (US)

Correspondence Address: Thomas Van Zandt, 5255 Stevens Creek Blvd. PMG # 299, Santa Clara, CA, 95051, US

(21) Appl. No.: 10/629,393

(22) Filed: Jul. 29, 2003

Related U.S. Application Data
(60) Provisional application No. 60/399,510, filed on Jul. 30, 2002.

(51) Int. Cl. H04M 1/64; H04M 3/42

(52) U.S. Cl. 379/207.15; 379/88.19

(57) ABSTRACT

A method and system for an automatic messaging service. A central cite receives caller identification information and a corresponding response instruction from a remote user. Upon receipt of a call, the central cite automatically verifies the caller's identification and responds according to the user's instructions. For one embodiment, the caller identification information is the caller's originating phone number and the automatic response is to forward the call to an alternative phone number specified by the user.

### CROSS-REFERENCE TO RELATED APPLICATION

This application is a non-provisional application claiming priority to provisional application Ser. No. 60/399,510, filed on Jul. 30, 2002, entitled “Automatic Messaging System,” the teachings of which are incorporated by reference herein.

### FIELD

Embodiments of the invention relate generally to the field of digital communication systems and more specifically to an automatic messaging system.

### BACKGROUND

Typical messaging services allow a user to have a message presented to any number of people who call at a time when the user is unavailable to take the call personally. In the simplest scenario, a user will call their messaging service and inform a system operator that they will be unavailable for calls, perhaps for a specified time. When a caller attempts to place a call to the user, the call is forwarded to the messaging service and the operator presents the message from the user. The user may also leave specific messages for specific callers. The user may also provide an alternative phone number that the call may be forwarded to.

The typical messaging service offers certain advantages over a typical telephone answering machine. For example, messages, both specific and general, can be revised by simply calling the messaging service, that is, the user does not have to reprogram an answering machine. Also, the user does not have to be concerned that the answering machine will fail to operate. Moreover, for cell phones, which have dramatically increased in use over the past two decades, all the functionality of an answering machine can not be included without unduly adding to the bulk and power consumption of the cell phone. Typically with cell phones today, a user calls in to a central cite and records an out-going message. When a caller places a call to the cell phone which is not answered, the out-going message is presented to the caller from the central cite. This is similar to new telephone services that eliminate the need for a user to have an answering machine connected to a telephone. Such services allow the user to record an out-going message at a central cite, the out-going message is then presented to a caller if the user does not answer their phone for a specified number of rings (e.g., 4 rings). Such systems provide some of the advantage of a messaging service (e.g., no need for an answering machine and hence no concern that the device will fail). But such services do not typically provide all the benefits of messaging services or answering machines. For example, such services do not provide for specific messages for specific callers. Or for example, a user may have the option of having his calls forwarded to his cell phone, but not want to receive many of the calls. Answering the unwanted calls may prove costly and annoying.

### SUMMARY

An embodiment of the present invention provides a method and system for an automatic messaging service. A central cite receives, from a remote user, caller identification information and a corresponding response instruction. Upon receipt of a call, the central cite automatically identifies the call or verifies the caller's identification and responds according to the user's instructions.

Other features and advantages of embodiments of the present invention will be apparent from the accompanying drawings, and from the detailed description, that follows below.

### BRIEF DESCRIPTION OF THE DRAWINGS

The invention may be best understood by referring to the following description and accompanying drawings that are used to illustrate embodiments of the invention. In the drawings:

FIG. 1 is a process flow diagram in accordance with one embodiment of the present invention;

FIG. 2 is a functional block diagram of a system in accordance with one embodiment of the present invention; and

FIG. 3 is a block diagram illustrating one embodiment of a processing system 300 that may be used for the central cite 205 in accordance with an embodiment of the present invention.

### DETAILED DESCRIPTION

A method and system for an automatic messaging service is disclosed. For one embodiment, a central cite receives caller identification information and a corresponding response instruction from a remote user. Upon receipt of a call, the central cite automatically verifies the caller's identification and responds according to the user's instructions. For one embodiment, the caller identification information is the caller's originating phone number and the automatic response is to forward the call to an alternative phone number specified by the user.

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

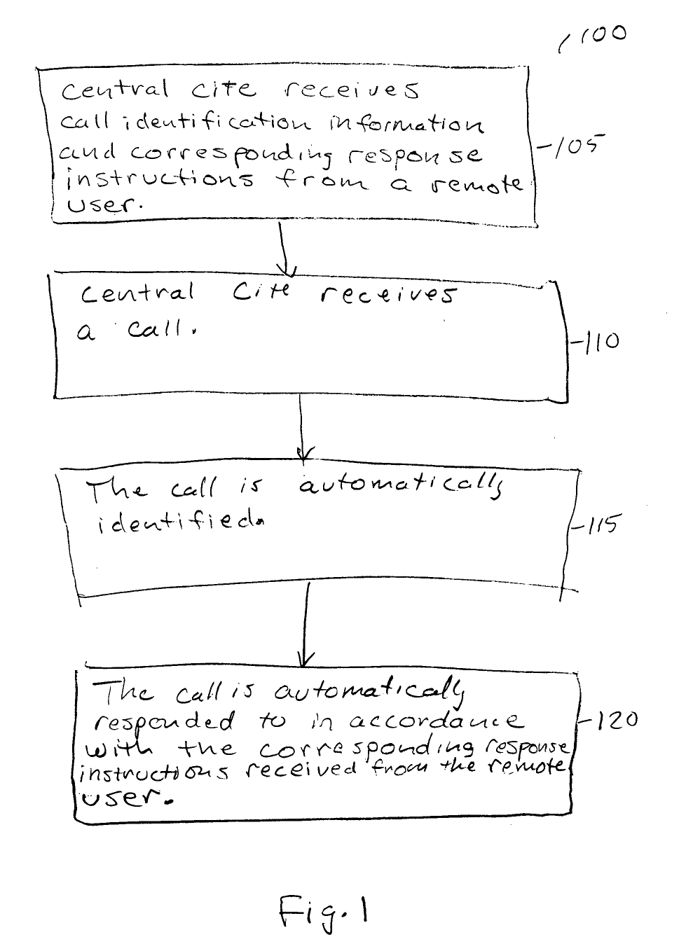

FIG. 1 is a process flow diagram in accordance with one embodiment of the present invention. Process 100, shown in FIG. 1, begins with operation 105 in which a central cite receives call identification information and corresponding response instructions from a remote user. For example, a remote user may call the central cite and provide call identification information in the form of an originating telephone number of the call. Alternatively, the call identification information may be a name of a prospective caller or may be a pre-arranged tonal or numeric code, or some other form of identification. The remote user also provides response instructions for the call identification information, which may be a specific recorded text, voice, and/or video message. For one embodiment, the corresponding response instructions may be to automatically forward the call to an alternative telephone number of the remote user.

At operation 110 a call is received at the central cite. For one embodiment, the received call is originally placed to the telephone number of the remote user and upon a “busy signal”, or no answer at the remote user's telephone, the call is automatically forwarded to the central cite.

At operation 115, the call is automatically identified. For an embodiment in which the call identification information provided by the remote user is an originating phone number of the call, the call is automatically identified through a “caller ID” mechanism Such “caller ID” functionality is well known in the art for the purpose of call screening and/or call avoidance. For an alternative embodiment where the call identification information is a caller name, the call may be automatically identified by prompting the caller to say their name and identifying the call via a speech recognition mechanism In a preferred embodiment, such a speech recognition system is based on overall speech patterns so that the call may be identified by comparing the remote user's input with the caller's input.

At operation 120 the call is responded to automatically in accordance with the corresponding response instructions received from the remote user. For example, the remote user may have recorded a specific message for a particular caller. In an alternative embodiment, the remote user may have instructed that a call from a particular caller be forwarded to a specified alternative telephone number of the remote user.

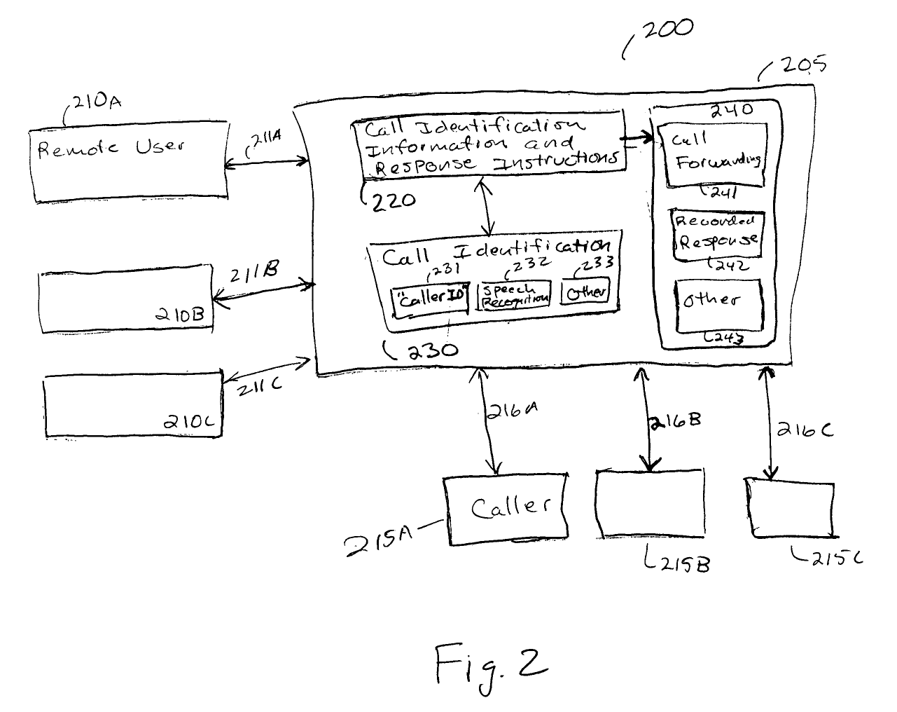

FIG. 2 is a functional block diagram of a system in accordance with one embodiment of the present invention. System 200 includes a central cite 205 coupled to a number of remote users 210A-210C and a number of callers 215A-215C via communication links 211A-211C and 216A-216C, respectively. Links 211A-211C and 216A-216C may be wired or radio telephone links, or network links, for example, which may communicate any combination of a number of different types of data including for example video, audio, graphics, text, multi-media or the like. For example the data may be audio/video data, such as programs with moving images and sound. However, it will be appreciated that the data files communicated in accordance with the teachings of various embodiments of the present invention are not limited only to audio/video data.

Central cite 205 includes user input module 220 for receiving and storing call identification information and corresponding response instructions. Coupled to the user input module 220 is call identification module 230. Call identification module 230 uses the call identification information from user input module 220 to identify a call. Depending on the form of the call identification information, call identification module 230 may contain a number of distinct units such as caller ID unit 231, speech recognition unit 232, or other call identification functionality shown for example as unit 233.

Also coupled to user input module 220 is call response module 240. Call response module 240 uses the response instructions from user input module 220 to respond to a call. Depending on the response instructions, call response module 240 may contain a number of distinct units such as call forwarding unit 241, recorded response unit 242, or other call response functionality shown for example as unit 243.

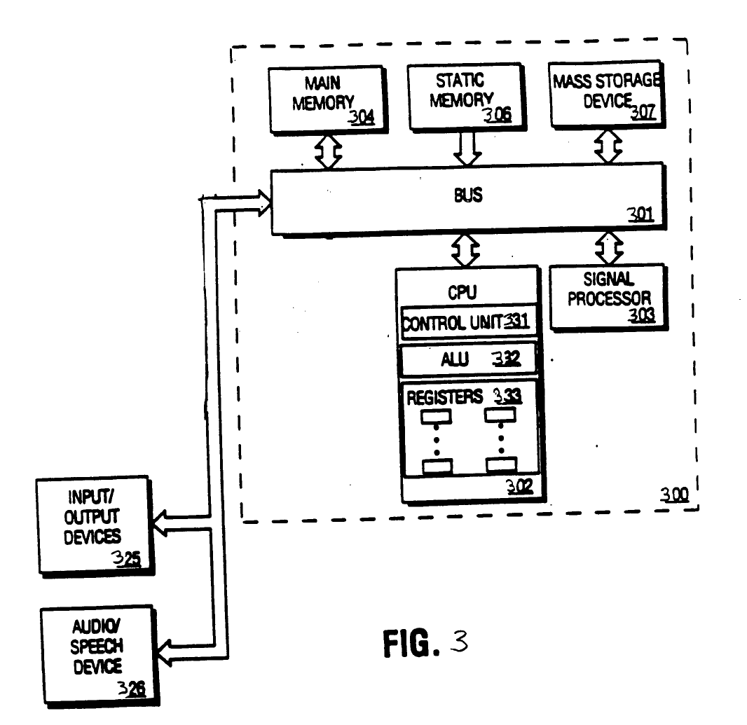

FIG. 3 is a block diagram illustrating one embodiment of a processing system 300 that may be used for the central cite 205 in accordance with an embodiment of the present invention. For alternative embodiments of the present invention, processing system 300 may be a mainframe, personal, or portable computer. For one embodiment, each module of central cite 205 contains a processing system.

The components of processing system 300 are exemplary in which one or more components may be omitted or added. For example, one or more memory devices may be utilized for processing system 300.

Referring to FIG. 3, processing system 300 includes a central processing unit 302 and a signal processor 303 coupled to a main memory 304, static memory 306, and mass storage device 307 via bus 301. Processing system 300 may also be coupled to input/output (I/O) devices 325, and audio/speech device 326 via bus 301. Bus 301 is a standard system bus for communicating information and signals. CPU 302 and signal processor 303 are processing units for processing system 300. CPU 302 or signal processor 303 or both may be used to process information and/or signals for processing system 300. CPU 302 includes a control unit 331, an arithmetic logic unit (ALU) 332, and several registers 333, which are used to process information and signals. Signal processor 303 may also include similar components as CPU 302.

Main memory 304 may be, e.g., a random access memory (RAM) or some other dynamic storage device, for storing information or instructions (program code), which are used by CPU 302 or signal processor 303. Main memory 304 may store temporary variables or other intermediate information during execution of instructions by CPU 302 or signal processor 303. Static memory 306, may be, e.g., a read only memory (ROM) and/or other static storage devices, for storing information or instructions, which may also be used by CPU 302 or signal processor 303. Mass storage device 307 may be, e.g., a hard or floppy disk drive or optical disk drive, for storing information or instructions for processing system 300.

The invention includes various operations. The operations of the invention may be performed by hardware components or may be embodied in machine-executable instructions, which may be used to cause a general-purpose or special-purpose processor or logic circuits programmed with the instructions to perform the operations. Alternatively, the steps may be performed by a combination of hardware and software. The invention may be provided as a computer program product that may include a machine-readable medium having stored thereon instructions, which may be used to program a computer (or other electronic devices) to perform a process according to the invention. The machine-readable medium may include, but is not limited to, floppy diskettes, optical disks, CD-ROMs, and magneto-optical disks, ROMs, RAMs, EPROMs, EEPROMS, magnet or optical cards, flash memory, or other type of media/machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication cell (e.g., a modem or network connection). All operations may be performed at the same central cite or, alternatively, one or more operations may be performed elsewhere.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
receiving, at a central site, a call identification information and a corresponding response instruction, from a remote user;
receiving a call;
automatically identifying the call; and
responding to the call in accordance with the corresponding response instruction.

2. The method of claim 1, wherein the call identification information is an originating telephone number of the call.

3. The method of claim 1, wherein in the call identification information is a name of the caller.

4. The method of claim 1, wherein receiving a call includes receiving a call forwarded to the central cite after the call was originally directed to the remote user's telephone.

5. The method of claim 1, wherein the corresponding response instruction includes presenting a particular recorded voice message.

6. The method of claim 1, wherein the corresponding response instruction includes forwarding the call to a particular alternative telephone number of the remote user.

7. A system comprising:
means for receiving, at a central site, a call identification information and a corresponding response instruction, from a remote user;
means for receiving a call;
means for automatically identifying the call; and
means for responding to the call in accordance with the corresponding response instruction.

8. The system of claim 7, wherein the call identification information is an originating telephone number of the call.

9. The system of claim 7, wherein in the call identification information is a name of the caller.

10. The system of claim 7, wherein receiving a call includes receiving a call forwarded to the central cite after the call was originally directed to the remote user's telephone.

11. The system of claim 7, wherein the corresponding response instruction includes presenting a particular recorded voice message.

12. The system of claim 7, wherein the corresponding response instruction includes forwarding the call to a particular alternative telephone number of the remote user.

13. A machine-readable medium that provides executable instructions, which when executed by a processor, cause the processor to perform a method, the method comprising:
receiving, at a central site, a call identification information and a corresponding response instruction, from a remote user;
receiving a call;
automatically identifying the call; and
responding to the call in accordance with the corresponding response instruction.

14. The machine-readable medium of claim 13, wherein the call identification information is an originating telephone number of the call.

15. The machine-readable medium of claim 13, wherein in the call identification information is a name of the caller.

16. The machine-readable medium of claim 13, wherein receiving a call includes receiving a call forwarded to the central cite after the call was originally directed to the remote user's telephone.

17. The machine-readable medium of claim 13, wherein the corresponding response instruction includes presenting a particular recorded voice message.

18. The machine-readable medium of claim 13, wherein the corresponding response instruction includes forwarding the call to a particular alternative telephone number of the remote user.
